(19) United States
(12) Patent Application Publication
(10) Pub. No.: US 2021/0371016 A1
(43) Pub. Date: Dec. 2, 2021

(54) Rack System for Pickup Trucks

(71) Applicants: Jeremy Luchini, Lancaster, MA (US); Sean May, Lancaster, MA (US); Nicolaas op den Kelder, Lancaster, MA (US)

(72) Inventors: Jeremy Luchini, Lancaster, MA (US); Sean May, Lancaster, MA (US); Nicolaas op den Kelder, Lancaster, MA (US)

(21) Appl. No.: 16/888,700

(22) Filed: May 30, 2020

(51) Int. Cl. B62D 33/02

(52) U.S. Cl. CPC B62D 33/0207

(57) ABSTRACT

Provided herein is a novel truck bed mounted rack which advantageously combines the ability to transport or store cargo in one configuration while establishing a framework for a sheltered, spacious environment in the other configuration. The expandable truck rack system of the invention combines useful functions of racks, tonneaus and roof tents into a single universal solution.

### CROSS-REFERENCE TO RELATED APPLICATIONS

The present invention claims priority to provisional patent application 62/824,991 for a Rack System for Pickup Trucks filed with the USPTO on May 31, 2019, the contents of which is incorporated herein in its entirety.

### TECHNICAL FIELD

The following relates generally to a utility rack. In particular, the following relates to a multiple-position utility rack system for use with a pickup truck.

### BACKGROUND OF THE INVENTION

Pickup trucks are designed with a very useful cargo storage space, known as the truck bed. Pickup truck owners install racks over the truck bed area to add functionality for transporting larger items, such as ladders or kayaks with relative ease. Pickup truck owners may also install tonneau covers on top of the open truck bed area to add functionality for protecting personal items against theft or weather elements. Disclosed herein is a rack system for pickup trucks that merges these two functions, cargo transport and security, into one expandable rack system, while introducing a third novel function that existing racks and tonneau covers do not provide on their own, a safe framework for a sheltered environment for non-driving, recreational use, such as camping.

### BRIEF SUMMARY OF THE INVENTION

The present invention is an expandable rack system for pickup trucks that performs as a cargo rack and tonneau cover in one position and serves as a framework for a sheltered environment in another position. The purpose of the invention is to introduce additional functionality, convenience and advantages that both existing truck racks and rooftop sheltered environments do not currently provide.

### DETAILED DESCRIPTION OF THE INVENTION

The present invention is an expandable rack system apparatus for pickup truck vehicles. The expandable rack system comprises of aluminum tube sections that assemble and disassemble with threaded bolt connections. There is no modification of the original truck bed area required to mount the expandable rack system to the truck bed. As illustrated in the figures, examples of the invention comprise an expandable rack system. As illustrated in FIGS. 1-3, the first assembled frame section, the inner cage 1, is the foundation for the overall expandable rack framework and is mounted inside the truck bed and fixed to the floor or bed sides with threaded bolts. The inner cage can be removed at any point to return the pickup truck to original condition. The storage box exterior walls 2 are then fixed to the inner cage frame and storage bins 3 inserted and secured. The vertical corner posts 4 are then attached to the inner cage frame and establish the rack travel height of the overall framework. The second frame section, the upper rack 5, inserts into the vertical corner posts and is free to move up and down its intended path. The upper rack section is secured across multiple positions using lock pins. The remaining frame sections, the tonneau covers 8 and tonneau frames 11, are independent trays that slide into the inner cage section from the sides. Safety railings are installed to the top of each tonneau and comprise of a fixed lower guard rail 9 and an upper telescoping guard rail 10. These tonneaus, when assembled, become functional platforms and are secured across multiple positions using lock pins. The expandable rack system is now fully assembled with integrated tonneau and two main configurations, cargo transport mode and camping mode.

The integrated tonneau covers have two configurations. The closed tonneau configuration is for cargo transport mode and protection of items in the truck bed. The open tonneau configuration is for non-driving functions only and creates seating platforms with guard rails off both sides of the truck bed. The traverse sliding direction of each tonneau cover creates accessibility to the truck bed floor to provide maximum floor space in camping mode.

The integrated telescoping vertical posts have two configurations. The low-post configuration secures the upper rack section for large cargo transport mode. The high-post configuration secures the upper rack section for non-driving functions only and places the framework in such a way as to maximize headroom for individuals standing or moving around the floor space in camping mode.

These procedures are involved in the recreational use of the expandable rack system: First, fold down the truck bed tailgate. Next, remove the tonneau cover lock pins by hand. Next, position the tonneau covers into the open configuration as these frames are free to move outward with a transverse sliding action, similar to the ease of pulling a drawer outward from a desk. Next, the telescoping vertical post lock pins are removed by hand. Next, while standing inside the truck bed, the upper rack section is pushed upward by hand, with a vertical sliding action, similar to the ease of opening an umbrella. With the rack expansion completed, the entire framework is secured again by inserting lock pins. Lastly, a fitted protective canvas 14 with entry door 15 is installed by placing it over the framework to provide sheltered environment and recreational use.

### BRIEF DESCRIPTION OF THE DRAWINGS

FIG. 1: Depicts the rack system in open position, for recreational use

Inner cage frame 1

Storage box exterior walls 2

Storage bins 3

Vertical corner posts 4

Upper rack frame 5

Roof peak crossbar 6

Side support connector 7

Tonneau cover and seating platform 8

Lower fixed guard rail 9

Upper telescoping guard rail 10

Telescoping tonneau frame 11

Fixed front guide 12

Fixed rear guide 13

FIG. 2: Depicts the rack system in closed position, for transport and storage of cargo.

Inner cage frame 1

Storage box exterior walls 2

Storage bins 3

Vertical corner posts 4

Upper rack frame 5

Tonneau cover and seating platform 8

Lower fixed guard rail 9

Upper telescoping guard rail 10

Telescoping tonneau frame 11

Fixed front guide 12

Fixed rear guide 13

FIG. 3: Depicts the rack system in open position, for shelter and enclosed living space use

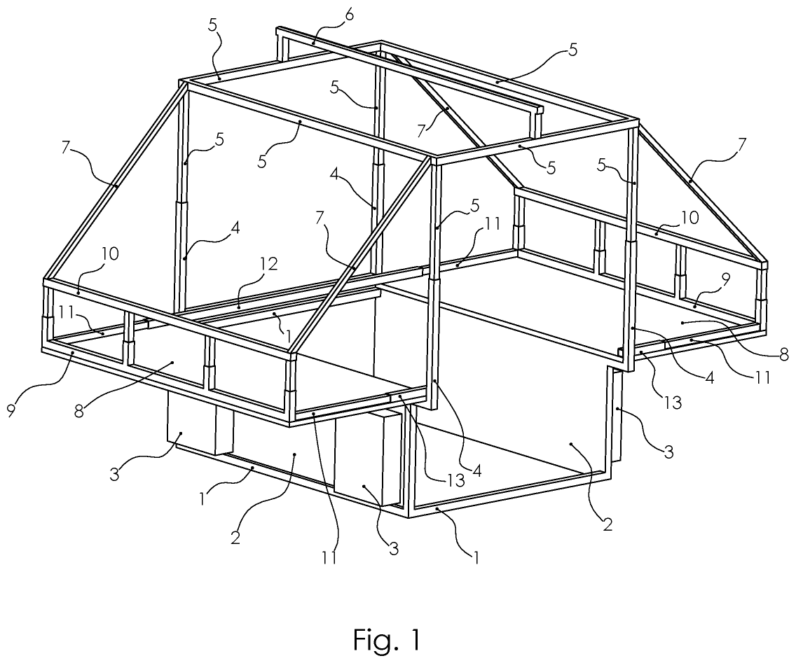

Canvas 14

Tailgate entry door 15

1. A rack system for a pickup truck comprising of an expandable framework that includes: a fixed-mounted inner frame section, a vertically-telescoping frame section that provides cargo transport support when positioned low and sheltered environment roof support when positioned high, and two horizontally-sliding frame sections that provide cargo security when positioned inward and seating platforms for when positioned outward.
